(19) United States
(12) Patent Application Publication
(10) Pub. No.: US 2022/0120065 A1
(43) Pub. Date: Apr. 21, 2022

(54) TELESCOPIC SHOWER

(71) Applicant: FUJIAN XIHE SANITARY WARE TECHNOLOGY CO., LTD., Fujian (CN)

(72) Inventors: Xiaofa LIN, Fujian (CN); Xiaoshan LIN, Fujian (CN); Zhigang WAN, Fujian (CN); Feiming DENG, Fujian (CN); Zhiwei CHEN, Fujian (CN); Qiqiao LIU, Fujian (CN); Xiaoqing DENG, Fujian (CN)

(73) Assignee: FUJIAN XIHE SANITARY WARE TECHNOLOGY CO., LTD., Fujian (CN)

(21) Appl. No.: 17/378,785

(22) Filed: Jul. 19, 2021

(30) Foreign Application Priority Data
Oct. 21, 2020 (CN) 202011130111.6

(51) Int. Cl. E03C 1/04

(52) U.S. Cl. CPC E03C 1/0409

(57) ABSTRACT

A telescopic shower including a shower body, a telescopic sleeve, and a pressing assembly is provided. The shower body is provided with a first limiting groove and a second limiting groove in an extending direction of a water inlet pipe thereof. The telescopic sleeve and the shower body are slidably connected and form limitation and matching of rotation. A positioning block in the pressing assembly extends into the first limiting groove or the second limiting groove so as to position different positions of the shower body when the shower body extends and retracts relative to the telescopic sleeve.

### CROSS-REFERENCE TO RELATED APPLICATION

This application claims the priority benefit of Chinese application serial no. 202011130111.6, filed on Oct. 21, 2020. The entirety of the above-mentioned patent application is hereby incorporated by reference herein and made a part of this specification.

### BACKGROUND

### Technical Field

The disclosure relates to the field of shower structures, and in particular, relates to a telescopic shower.

### Description of Related Art

In the prior art, lengths of the handles of hand-held showers are fixed and are not telescopic. Especially for a shower with a rubbing function, since the length of the handle is fixed, the shower may not be able to rub the back and other parts during use due to the length of the handle, and the use experience is thus poor.

### SUMMARY

The following is a brief description of the subject to be explained in detail in the specification, and the brief description is not intended to limit the protection scope of the claims.

The disclosure provides a telescopic shower including a shower body, a telescopic sleeve, and a pressing assembly. The shower body is provided with a first limiting groove and a second limiting groove in an extending direction of a water inlet pipe thereof. The telescopic sleeve and the shower body are slidably connected and form limitation and matching of rotation. A positioning block in the pressing assembly extends into the first limiting groove or the second limiting groove so as to position different positions of the shower body when the shower body extends and retracts relative to the telescopic sleeve.

The pressing assembly further includes a pressing spring. The pressing spring is disposed between an outer wall of the telescopic sleeve and a button such that the button is kept in a first position when the positioning block extends into the first limiting groove or the second limiting groove.

The positioning block is provided with a first pin shaft, and the button is provided with a first shaft hole configured to receive the first pin shaft. The first shaft hole allows the first pin shaft to slide and rotate therein. As such, the positioning block may roughly move in an extending direction of a positioning hole without being affected by swinging of the button.

The telescopic sleeve is provided with the positioning hole configured to allow the positioning block to penetrate through. An outer wall of the telescopic sleeve is provided with an orientation portion having a radial thickness. The orientation portion forms an orientation channel communicating with the positioning hole, and gap matching is provided between the orientation channel and the positioning block to limit inclination of the positioning block in a first direction. As such, stability of the positioning block is ensured when the positioning block extends into the first limiting groove or the second limiting groove.

One end of the orientation channel away from the positioning hole is provided with a guiding surface connected to the orientation channel and inclined to an extending direction of the orientation channel, and the guiding surface is configured to receive the positioning block when the button swings to a second position. As such, the positioning block is prevented from being detached from the orientation channel or is prevented from not being able to be inserted into the orientation channel when being driven to move towards a position of the water inlet pipe.

The button is provided with a second pin shaft. An outer wall of the telescopic sleeve is provided with a rotating shaft base, and the rotating shaft base is provided with a second shaft hole rotatably matched with the second pin shaft. The second shaft hole is provided with a first opening, and a direction of the first opening is inclined relative to a movement direction of the positioning block. The first opening is configured to allow the second pin shaft to be inserted and installed into the second shaft hole. The second pin shaft is prevented from being detached from the second shaft hole owing to the inclination arrangement of the first opening.

A telescopic spring is further included, and the telescopic spring is disposed between the telescopic sleeve and the water inlet pipe to drive the telescopic sleeve to be away from the water outlet portion.

An inner wall of the telescopic sleeve is provided with a protruding block in a radial direction. The protruding block is provided with a spring receiving chamber extending in the first direction, and the spring receiving chamber is provided with a second opening facing the water outlet portion. The spring receiving chamber is configured to receive the telescopic spring. An outer wall of the water inlet pipe is provided with a sliding groove in a radial direction, and the sliding groove extends in the first direction and is always inserted into the protruding block in a process when the telescopic sleeve slides relative to the water inlet pipe to form the limitation and matching of rotation.

An abutting block is further included. The abutting block is partially received in the spring receiving chamber, one end of the abutting block abuts against the telescopic spring, and the other end of the abutting block abuts against an abutting surface of the water inlet pipe facing the second opening. As such, the shower body is driven to automatically extend out from the telescopic sleeve when the positioning block is detached from the first limiting groove, and the telescopic spring is prevented from being detached from the spring receiving chamber.

An elastic member is further included, and the elastic member is installed on the outer wall of the water inlet pipe and abuts against the inner wall of the telescopic sleeve. As such, damping is provided when the shower body slides relative to the telescopic sleeve, and dirt on the inner wall of the telescopic sleeve is also cleaned.

### BRIEF DESCRIPTION OF THE DRAWINGS

The accompanying drawings are included to provide a further understanding of the disclosure.

FIG. 1 is an exploded view of a structure of a telescopic shower according to an embodiment of the disclosure.

FIG. 2 is a schematic view of a structure of a shower body of the telescopic shower in FIG. 1.

FIG. 3 is a schematic view of a structure of a telescopic sleeve in FIG. 1.

FIG. 4 is a schematic view of a structure of a pressing assembly in FIG. 1.

FIG. 5 is a schematic view of a structure of a positioning block in FIG. 4.

FIG. 6 is a view of the telescopic shower in FIG. 1 in a state when the positioning block is used to be matched with a first limiting groove.

FIG. 7 is a view of the telescopic shower in FIG. 1 in a state when the positioning block is used to be detached from the first limiting groove.

FIG. 8 is a schematic cross-sectional view of the telescopic shower in FIG. 1 passing through a telescopic spring and extending out.

### DESCRIPTION OF THE EMBODIMENTS

The accompanying drawings are included to provide a clear and complete description of the technical solutions provided in the embodiments of the disclosure.

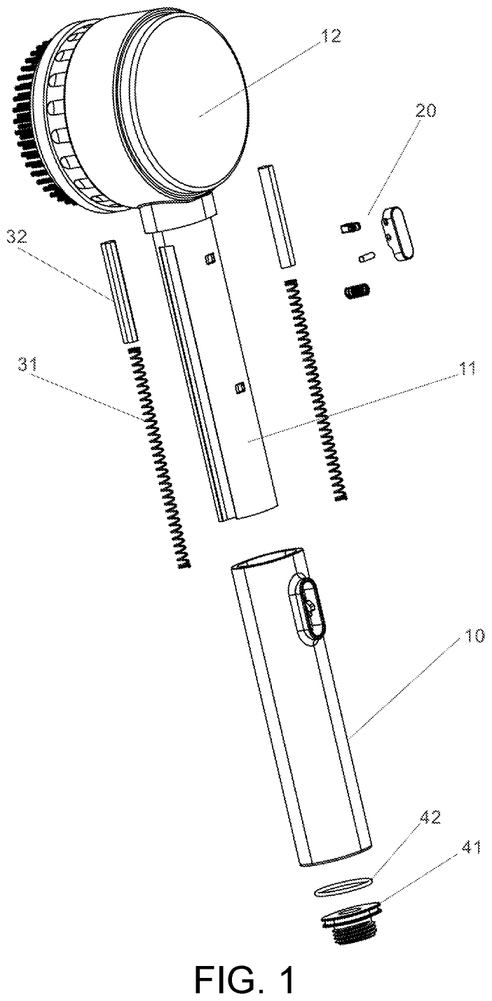

With reference to FIG. 1, FIG. 1 illustrates a structure of a telescopic shower according to an embodiment of the disclosure, and the telescopic shower mainly includes a shower body, a telescopic sleeve 10, a pressing assembly 20, a telescopic spring 31, an abutting block 32, and an elastic member 42.

The shower body is a water outlet structure of the telescopic shower in this embodiment and includes a water outlet portion 12 and a water inlet pipe.

The water outlet portion 12 is a water outlet end of the shower body and is configured to provide a water outlet function for the telescopic shower. The water outlet portion 12 includes a surface cover, and the surface cover is provided with a plurality of water outlet holes. After flowing through an internal waterway of the water outlet portion 12, water is discharged from the water outlet holes on the surface cover. A surface of the surface cover facing the outside is provided with a brush extending in a water outlet direction. The brush may add a sweeping function to the shower and may be used for massaging or cleaning the surface of the human body or the surface of other objects.

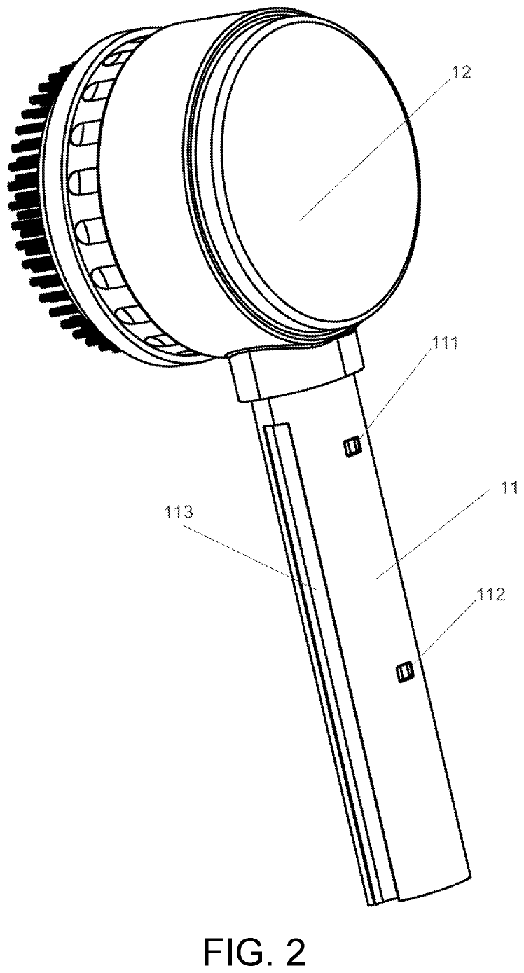

As shown in FIG. 1 and FIG. 2, the water inlet pipe includes a pipe body 11 and a connector 41.

The direction close to the water outlet portion 12 is treated as the front end and the direction away from the water outlet portion 12 is treated as the back end herein, and orientations of the following components and structures are described. A front end of the pipe body 11 is fixedly connected to the water outlet portion 12, and in actual manufacturing, the pipe body 11 and the water outlet portion 12 may be formed into an integrated structure. An internal pipeline of the pipe body 11 communicates with the internal waterway of the water outlet portion 12 and is configured to guide a water flow into the water outlet portion 12. A first limiting surface facing the front end of the pipe body 11 is formed on a position where the pipe body 11 and the water outlet portion 12 are connected.

The pipe body 11 is a round pipe with a certain length, and an extending direction thereof is a first direction. The first direction herein may be parallel to an axis of the pipe body 11 and faces a position of the front end of the pipe body 11 and may also be parallel to the axis of the pipe body 11 and faces a position of a back end of the pipe body 11. In this embodiment, for ease of description, the first direction is defined as being parallel to the axis of the pipe body 11 and facing the position of the back end of the pipe body 11. Since the pipe body 11 is a round pipe and has a plurality of symmetric surfaces along the axis, one of the symmetric surfaces is defined as a first symmetric surface herein, and such symmetric surface is parallel to the water outlet direction of the water outlet portion 12. More precisely, as shown in FIG. 1, the shower body may be treated as a symmetric shape, and a symmetric surface of the shower body is the aforementioned first symmetric surface.

A first limiting groove 111 and a second limiting groove 112 are distributed and provided on an outer wall of the pipe body 11 along the first direction in sequence. The first limiting groove 111 is located at a position close to the front end of the pipe body 11, the second limiting groove 112 is located at a position close to the back end of the pipe body 11, and the two both intersect the first symmetric surface.

Each of the first limiting groove 111 and the second limiting groove 112 has four connected side walls. Two of the side walls opposite to each other are both perpendicular to the first symmetric surface, and the other two side walls opposite to each other are inclined from an outer wall surface of the pipe body 11 towards an internal portion of the pipe body 11 facing a position where the first symmetric surface is located.

The outer wall of the pipe body 11 is provided with a sliding groove 113 recessed in a radial direction thereof. The sliding groove 113 extends in the first direction, one end thereof close to the water outlet portion 12 has a wall surface for abutting, and the other end thereof extends to the back end of the pipe body 11. Further, two sliding grooves 113 are provided, and the two sliding grooves 113 are symmetrically arranged relative to the first symmetric surface.

The connector 41 is configured to be connected to an external water supply hose and includes a screwing portion provided with a screw thread and configured to be screwed with an external connector and a connection portion configured to be connected to the pipe body 11. The connection portion may be treated as a circular plate structure. Certainly, a through hole is provided on the connector 41 along an axis of the connector 41, and the water flow may pass through the through hole on the connector 41 to enter into the pipe body 11 to supply water for the shower. The connection portion of the connector 41 is fixedly connected to the back end of the pipe body 11 through welding, and a diameter of the connection portion is slightly larger than a diameter of the outer wall of the pipe body 11. In this way, a portion of the connection portion exposed relative to the pipe body 11 forms a second limiting surface facing the front end of the pipe body 11. A sealing ring groove is formed on a periphery of the connection portion, and the sealing ring groove is used for installation of the elastic member 42. In this embodiment, the elastic member 42 is a sealing ring made of rubber or silicone and may be sleeved on the sealing ring groove on the outer periphery of the connection portion.

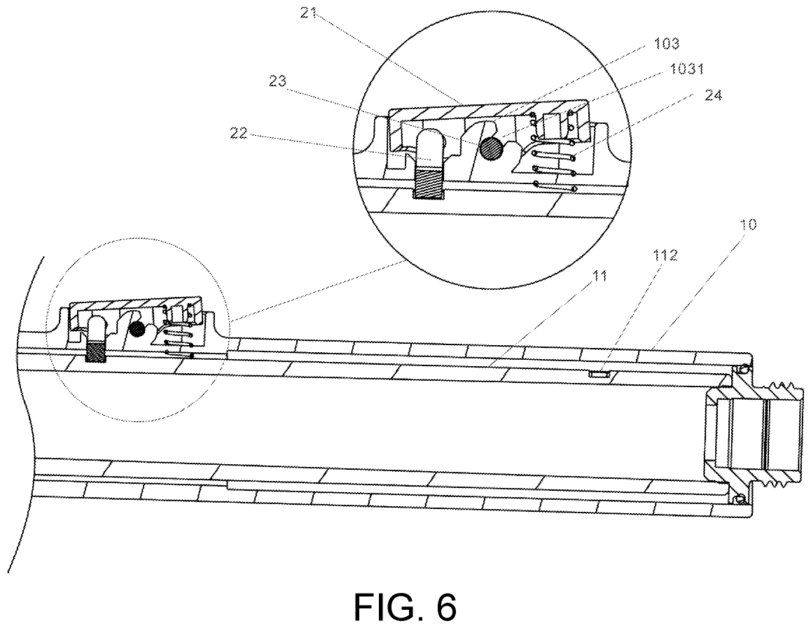

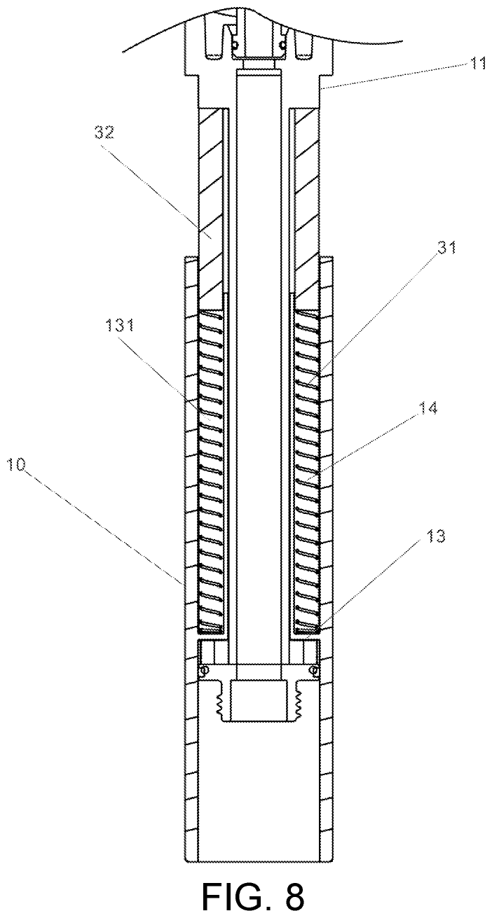

With reference to FIG. 1, FIG. 6, and FIG. 8, the telescopic sleeve 10 is a pipe-shaped member with a circular cross section, and a diameter of an inner wall thereof is approximately equal to the diameter of the outer wall of the pipe body 11. In this way, the pipe body 11 may be inserted into the telescopic sleeve 10 and form a gap matching and may slide relative to the telescopic sleeve 10. Similarly, the telescopic sleeve 10 also has a plurality of symmetric surfaces along an axis thereof. When the pipe body 11 is inserted into the telescopic sleeve 10, the first symmetric surface on the pipe body 11 overlaps one symmetric surface on the telescopic sleeve 10. Such symmetric surface on the telescopic sleeve 10 is defined as a second symmetric surface herein. Note that when the pipe body 11 is completely inserted into the telescopic sleeve 10, the first limiting surface may abut against the front end of the telescopic sleeve 10 (the front end surface of the telescopic sleeve 10 is defined as a third limiting surface herein). At least the connection portion on the connector 41 may still be located within a range of the telescopic sleeve 10 now, and the elastic member 42 may abut against the inner wall of the telescopic sleeve 10. Such abutting may provide a certain amount of damping for sliding of the pipe body 11 relative to the telescopic sleeve 10.

The inner wall of the telescopic sleeve 10 is provided with a protruding block 13 disposed in a radial direction thereof. The protruding block 13 extends in a length direction of the telescopic sleeve 10 and forms a long strip structure, and a spring receiving chamber 14 is disposed in the protruding block 13 extending in the first direction. The spring receiving chamber 14 has a second opening facing the water outlet portion 12, and the other end thereof opposite to the second opening is a bottom wall formed by the protruding block 13 itself. In this embodiment, two protruding blocks 13 are respectively located on two sides of the second symmetric surface of the telescopic sleeve 10 and are symmetrically arranged relative to the second symmetric surface. In addition, a wall surface of each of the protruding blocks 13 facing the back end of the telescopic sleeve 10 is defined as a fourth limiting surface.

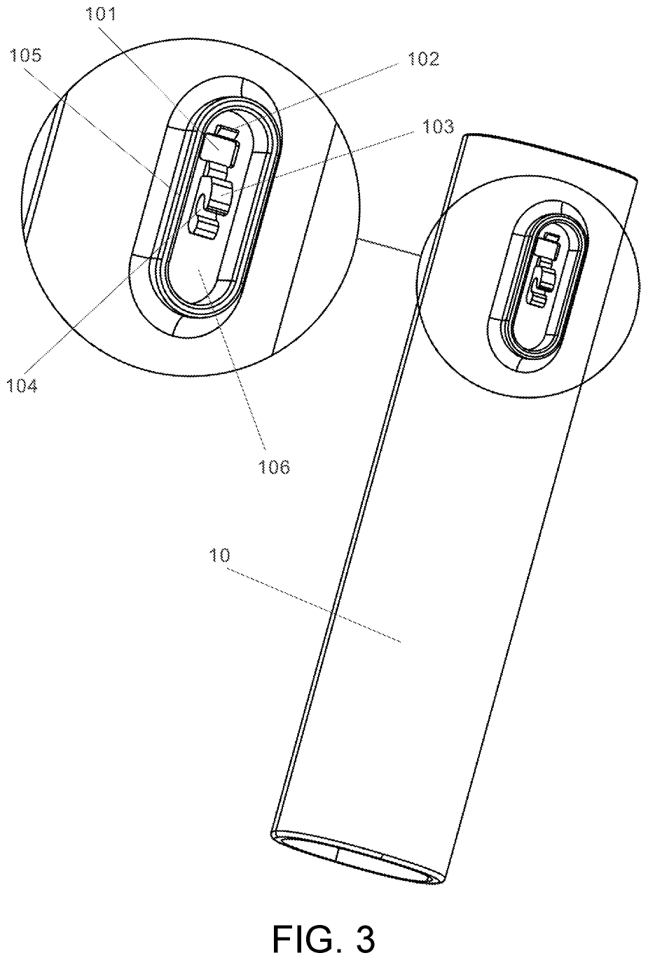

A position on an outer wall of the telescopic sleeve 10 close to the front end is provided with a closed ring-shaped protrusion 105 protruding from an outer wall surface. As shown in FIG. 3, the ring-shaped protrusion 105 and the outer wall of the telescopic sleeve 10 inside are matched to form a pressing chamber 106 having an opening top. In the pressing chamber 16, the outer wall of the telescopic sleeve 10 is provided with a positioning hole 101, an orientation portion 102, and a rotating shaft base 103.

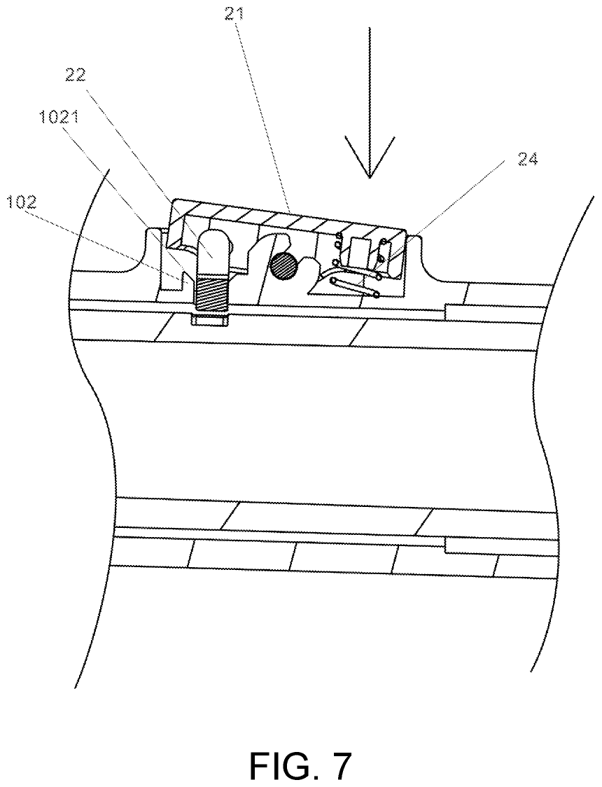

The rotating shaft base 103 is disposed on a center position of the pressing chamber 106, is formed by the outer wall of the telescopic sleeve 10 protruding outwards in the radial direction, and is provided with a second shaft hole 1031. The second shaft hole 1031 penetrates through the rotating shaft base 103 in a direction perpendicular to the second symmetric surface. Further, the rotating shaft base 103 is provided with a first opening communicating with the second shaft hole 1031. The first opening allows the second shaft hole 1031 to form a notch communicating with the outside at a peripheral position thereof. Moreover, as shown in FIG. 6 and FIG. 7, an opening direction of the first opening is provided with a certain angle relative to the radial direction of the telescopic sleeve 10, and the opening direction faces the back end of the telescopic sleeve 10.

The positioning hole 101 is disposed at the front of the rotating shaft base 103 and penetrates through a pipe wall of the telescopic sleeve 10 in the radial direction of the telescopic sleeve 10. The positioning hole 101 here is a through hole with a square cross section perpendicular to the radial direction of the telescopic sleeve 10.

Two orientation portions 102 are arranged, and one is located between the positioning hole 101 and the rotating shaft base 103, and the other one is located at the front of the positioning hole 101. The two may both be treated as protruding blocks disposed on the outer wall of the telescopic sleeve 10 and protruding outwards in the radial direction of the telescopic sleeve 10. As such, orientation portions 102 may have a certain thickness in the radial direction of the telescopic sleeve 10. Further, as shown in FIG. 7, two side walls of the orientation portion 102 opposite to each other and perpendicular to the second symmetric surface and two side walls of the positioning hole 101 perpendicular to the second symmetric surface are correspondingly located on a same plane. As such, the orientation portion 102 forms an orientation channel extending in the radial direction of the telescopic sleeve 10 and connected to the positioning hole 101. A length of two side walls of the orientation channel formed by matching with the positioning hole 101 and perpendicular to the second symmetric surface is greater than a wall thickness of the pipe wall of other positions of the telescopic sleeve 10. In addition, top ends of two protruding blocks acting as the orientation portions 102 are provided with an inclined guiding surface 1021. The guiding surface 1021 is equivalent to being disposed on the side walls of the orientation channel and is kept being connected to the side walls of the positioning hole 101. Further, the guiding surface 1021 is inclined relative to an extending direction of the orientation channel. That is, the guiding surface 1021 is inclined from an outer side of the orientation channel to an inner side of the orientation channel at one end of the orientation channel away from the positioning hole 101 and from a position away from the positioning hole 101 to a position close to the positioning hole 101. In this way, the orientation channel forms an outwardly opened structure at a top position thereof.

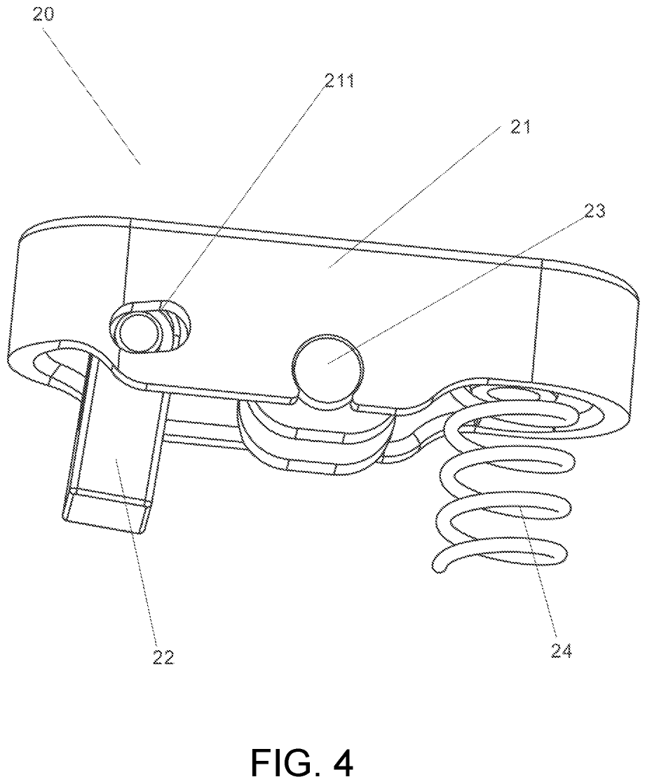

As shown in FIG. 4 to FIG. 7, the pressing assembly 20 includes a button 21, a positioning block 22, first pin shafts 221, second pin shafts 23, and a pressing spring 24.

A position and a structure of the pressing assembly 20 are described based on a state of the pressing assembly 20 after being installed onto the telescopic sleeve 10 in FIG. 6 or FIG. 7. The button 21 includes a plate-shaped pressing board. The pressing board is configured to allow a user to perform pressing, and a shape and size thereof is approximately similar to a shape and size surrounded by the ring-shaped protrusion 105. As such, the button 21 may be disposed inside the pressing chamber 106. Side walls of the button 21 are disposed on a periphery of the pressing board in a direction extending towards the telescopic sleeve 10, and the button 21 is allowed to form a chamber with an opening facing the telescopic sleeve 10. Such chamber may be used for installation of the positioning block 22, the second pin shafts 23, and the pressing spring 24.

The two side walls of the button 21 parallel to the second symmetric surface are respectively provided with first shaft holes 211 symmetrical to each other relative to the second symmetric surface. The first shaft holes 211 are close to a front end of the button 21, penetrate through the side walls of the button 21 in a direction perpendicular to the second symmetric surface, and form long strip structures extending towards the back end of the telescopic sleeve 10 in a direction parallel to the second symmetric surface. Besides, each of the first shaft holes 211 has a specific inclination angle relative to a surface where the pressing board is located. Such inclination angle may be adjusted according to actual needs, as long as the positioning block 22 may slide along the first shaft holes 211.

The two side walls of the button 21 parallel to the second symmetric surface are respectively provided with second pin shaft holes symmetrical to each other relative to the second symmetric surface. The second pin shaft holes are located at a center position of the button 21, penetrate through the side walls of the button 21 in the direction perpendicular to the second symmetric surface, and each have an opening facing the telescopic sleeve 10. In addition, cross sections of the second pin shaft holes in the direction perpendicular to the second symmetric surface are roughly elliptical, such that the second pin shaft holes exhibit the function of rotation prevention. The second pin shafts 23 are installed from the openings of the second pin shaft holes into the second pin shaft holes. The second pin shafts 23 may achieve rotation prevention together with the button 21 as being matched with shapes of the second pin shaft holes.

A spring installation post is disposed on a back end position of the button 21. The spring installation post is located in a chamber formed by the side walls of the button 21 and is formed by a side surface of the pressing board facing the telescopic sleeve 10 and extending in a direction perpendicular to the side surface. The pressing spring 24 may be sleeved on the spring installation post, such that the pressing spring 24 may be installed to the button 21.

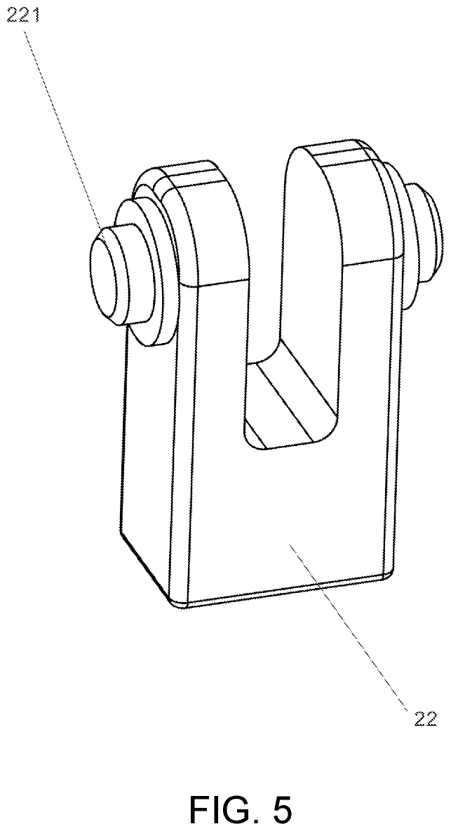

A structure of the positioning block 22 is shown in FIG. 5. The positioning block 22 includes a base, and two opposite extending arms are disposed on a side surface of the base in a direction extending away from the base. A receding groove is formed between the two extending arms. As such, the two extending arms are fixed only through end portions connected to the base and are not connected to other portions of the positioning block 22. Further, the two extending arms exhibit certain elasticity. When a force is applied to end portions of the two extending arms away from the base, the two extending arms may deform towards a position of the receding groove. As such, a distance between the end portions of the two extending arms away from the base is reduced, and in this way, the positioning block 22 may be conveniently installed. Two side surfaces of the two extending arms facing away from each other are provided with the first pin shafts 221 symmetrical relative to the second symmetric surface of the telescopic sleeve 10. Certainly, description is provided based on the state of the pressing assembly 20 after being installed onto the telescopic sleeve 10 herein, so positions of the first pin shafts 221 may be defined according to the above. In addition, an extending direction of the first pin shafts 221 is perpendicular to a plane of a side surface where the first pin shafts 221 are located. The first pin shafts 221 may be installed into the first shaft holes 211 on the button 21. A diameter of a circle surrounded by a side wall of each of the first pin shafts 221 is approximately similar to a width size of an inner wall of each of the first shaft holes 211. As such, the first pin shafts 221 may slide in an extending direction of the first shaft holes 211. When the positioning block 22 is to be installed, the end portions of the two extending arms on the positioning block 22 away from the base are to be brought close to each other and to be inserted into the chamber surrounded by the side walls of the button 21, and then the two first pin shafts 221 on the positioning block 22 are inserted into the first shaft holes 211. A size of the positioning block 22 allows the positioning block 22 to be installed on the button 21 without being detached.

As shown in FIG. 8, the abutting block 32 is a rod-shaped member, and a size of an outer wall shape thereof is approximately similar to a shape size of a cross section of the spring receiving chamber 14 perpendicular to the second symmetric surface, such that the abutting block 32 may be inserted into the spring receiving chamber 14.

Relationships among the telescopic sleeve 10, the water inlet pipe, the pressing assembly 20, the telescopic spring 31, and the abutting block 32 before and after assembly are described as follows.

The telescopic spring 31 is installed into the spring receiving chamber 14 first, and a back end of the telescopic spring 31 abuts against the bottom wall of the spring receiving chamber 14 formed by the protruding block 13. The abutting block 32 is then installed into the spring receiving chamber 14, and a back end of the abutting block 32 abuts against a front end of the telescopic spring 31. The abutting block 32 may now slide in the spring receiving chamber 14 and may force the telescopic spring 31 to compress when the abutting block 32 moves towards the back end of the telescopic sleeve 10. In addition, the abutting block 32 may also be used to prevent the telescopic spring 31 from being detached from the spring receiving chamber 14 and prevent the telescopic spring 31 from being exposed when the water inlet pipe extends outwards, and a favorable appearance of the shower is thereby provided.

The water inlet pipe is then installed into the telescopic sleeve 10. Note that the connector 41 is not yet fixed to the back end of the pipe body 11. The pipe body 11 is installed into the telescopic sleeve 10 from the front end of the telescopic sleeve 10 first. When the back end of the pipe body 11 is exposed from the back end of the telescopic sleeve 10, the connector 41 installed with the elastic member 42 is fixed to the back end of the pipe body 11. When the water inlet pipe slides relative to the telescopic sleeve 10, the elastic member 42 may abut against the inner wall of the telescopic sleeve 10. As such, the sliding of the shower body relative to the telescopic sleeve 10 produces a certain amount of damping, and the shower body is thus prevented from extending out from the telescopic sleeve 10 too quickly, and dirt on the inner wall of the telescopic sleeve 10 may also be cleaned. Further, when the pipe body 11 is inserted into the telescopic sleeve 10, the sliding groove 113 disposed on the outer wall of the pipe body 11 may correspond to the protruding block 13 on the inner wall of the telescopic sleeve 10. As such, limitation and matching of rotation is formed between the pipe body 11 and the telescopic sleeve 10. In this way, the pipe body 11 may no longer rotate relative to the telescopic sleeve 10, and the pipe body 11 is thus limited in a rotation direction. Further, when the water inlet pipe slides, the protruding block 13 is always kept being matched with the sliding groove 113. Accordingly, a front end of the abutting block 32 may abut against a wall surface of a front end of the sliding groove 113, and a force applied by the telescopic spring 31 on the shower body may be transferred through the abutting block 32. As such, the shower body of the telescopic shower may thus extend out automatically from the telescopic sleeve 10.

In addition, when the water inlet pipe is installed, note that the side of the pipe body 11 on which the first limiting groove 111 and the second limiting groove 112 are disposed is arranged to face the side of the telescopic sleeve 10 on which the positioning hole 101 is disposed. When the water inlet pipe slides relative to the telescopic sleeve 10, the first limiting groove 111 and the second limiting groove 112 are exposed from the positioning hole 101 in sequence.

The pressing assembly 20 is then installed, and the second pin shafts 23 are directly inserted from the first openings of the second shaft holes 1031 on the rotating shaft base 103 into the second shaft holes 1031. The positioning block 22 may be placed in the orientation channel and the positioning hole 101 now, the pressing spring 24 may be located between the telescopic sleeve 10 and the button 21, and one end of the pressing spring 24 may abut against the outer wall of the telescopic sleeve 10. In this way, the pressing assembly 20 is allowed to be kept in the state of being inclined towards the front of the button 21 when not being pressed, as shown in FIG. 6. Herein, owing to the effect produced by the pressing spring 24, a force direction of the button 21 is approximately parallel to the radial direction of the telescopic sleeve 10, and a force position is at the second pin shafts 23. As such, the second pin shafts 23 are effectively prevented from being detached from the second shaft holes 1031 when the first openings are arranged to be inclined.

A rotation axis where the second pin shafts 23 are located is a first axis of the button 21 when the button 21 swings relative to the telescopic sleeve 10. Surrounding the first axis, the button 21 swings between a first position and a second position. When the button 21 is located in the first position, the positioning block 22 may penetrate through the telescopic sleeve 10 to extend towards the outer wall of the water inlet pipe and extends into the first limiting groove 111 or the second limiting groove 112. When the button 21 is located in the second position, the positioning block 22 may be detached from the first limiting groove 111 and the second limiting groove 112.

To be specific, when the button 21 is not pressed, owing to the effect of the pressing spring 24, the button 21 has a tendency to move to the first position. When the pipe body 11 is entirely located in the telescopic sleeve 10, the positioning block 22 may penetrate through the orientation channel and the positioning hole 101 and extends into the first limiting groove 111. Through matching of the positioning block 22 and the side wall on the first limiting groove 111 perpendicular to the first symmetric surface, the shower body is prevented from extending out from the telescopic sleeve 10.

After the above state, when the button 21 is pressed, the positioning block 22 is detached from the first limiting groove 111, and as affected by the effect of the telescopic spring 31, the shower body extends out from the telescopic sleeve 10. Further, the second limiting surface on the water inlet pipe may abut against the fourth limiting surface on the telescopic sleeve 10. As such, the shower body keeps extending out from the telescopic sleeve 10, and the second limiting groove 112 is thus allowed to reach the position of the positioning hole 101. As affected by the pressing spring 24, the positioning block 22 then penetrates through the orientation channel and the positioning hole 101, extends into the second limiting groove 112, and limits movement of the shower body.

The button 21 is pressed again next, and the shower body is pushed so that the pipe body re-enters the telescopic sleeve 10. The first limiting surface on the water inlet pipe may now abut against the third limiting surface on the telescopic sleeve 10. At the same time, the button 21 is released, and as affected by the pressing spring 24, the positioning block 22 penetrates through the orientation channel and the positioning hole 101, extends into the first limiting groove 111, and locks the shower body.

In the foregoing process, the positioning block 22 may move along the orientation channel and the positioning hole 101. When the positioning block 22 extends into the first limiting groove 111 or the second limiting groove 112, one end of the positioning block 22 facing the water inlet pipe is abutted by the pipe body 11 as affected by the effect of the telescopic spring 31, and a force direction of the positioning block 22 is approximately opposite to the first direction. As such, the positioning block 22 is inclined in a direction relative to the extending direction of the orientation channel. As affected by such inclination, between the two side walls of the positioning block 22 perpendicular to the second symmetric surface, the side wall away from the first direction abuts against the side wall of the positioning hole 101, and the side wall facing the first direction abuts against the side wall of the orientation portion 102 located between the position hole 101 and the rotating shaft base 103. Since the orientation portion 102 increases in thickness in the radial direction of the telescopic sleeve 10, the lengths of the orientation channel and the positioning hole 101 in an axial direction are greater than the thickness of the telescopic sleeve 10. As such, an inclination angle of the positioning block 22 relative to the extending direction of the orientation channel may be kept to a small degree. In this way, the positioning block 22 may stably abut against and be matched with the side walls of the first limiting groove 111 and the second limiting groove 112 perpendicular to the first symmetric surface, and the shower body may thus be securely locked.

Further, in the above process, the positioning block 22 may slide along the first shaft holes 211 relative to the button 21. This is because the positioning block 22 needs to slide in the orientation channel and the positioning hole 101, and the positioning block 22 basically moves in the extending direction of the orientation channel in such moving process. The button 21 swings and moves relative to the telescopic sleeve 10, so the first shaft holes 211 are required to provide more moving space for the positioning block 22.

In addition, in the foregoing process, when the positioning block 22 leaves the first limiting groove 111 or the second limiting groove 112, the button 21 is located in the second position, and the space formed by the guiding surface 1021 may be used to receive the positioning block 22. When the positioning block 22 is required to re-extend into the first limiting groove 111 or the second limiting groove 112, the guiding surface 1021 may enable the positioning block 22 to move along the orientation channel and the positioning hole 101, so the positioning block 22 is prevented from being detached from a range of the orientation channel.

In the telescopic shower provided by the disclosure, a sleeve structure is formed between the shower body and the telescopic sleeve 10. In this way, the shower body may extend and retract relative to the telescopic sleeve 10. Further, the pressing assembly 20 is provided, and as the pressing assembly 20 may be used to control extending and retracting of the shower body, the shower body may be kept to be stable in both the extending position and the retracting position.

The description in the foregoing specification and embodiments is used to explain the protection scope of the disclosure but does not constitute a limitation on the protection scope of the disclosure.

What is claimed is:

1. A telescopic shower, comprising:
a shower body, provided with a water outlet portion and a water inlet pipe fixedly connected to the water outlet portion and communicating with a waterway, wherein the water inlet pipe extends in a first direction, and a first limiting groove and a second limiting groove are distributed on an outer wall of the water inlet pipe in the first direction;
a telescopic sleeve, sleeved on the water inlet pipe, slidably connected to the water inlet pipe in the first direction, wherein the telescopic sleeve forms limitation and matching of rotation with the water inlet pipe to be prevented from rotating around an axis parallel to the first direction relative to the water inlet pipe; and
a pressing assembly, comprising a positioning block and a button, wherein the positioning block is disposed on the button, penetrates through the telescopic sleeve, and extends towards the outer wall of the water inlet pipe, the button is swingably connected to the telescopic sleeve around a first axis and swings between a first position and a second position, the positioning block extends into the first limiting groove or the second limiting groove in the first position, and the positioning block is detached from the first limiting groove or the second limiting groove in the second position.

2. The telescopic shower according to claim 1, wherein the pressing assembly further comprises a pressing spring, and the pressing spring is disposed between an outer wall of the telescopic sleeve and the button such that the button is kept in the first position when the positioning block extends into the first limiting groove or the second limiting groove.

3. The telescopic shower according to claim 1, wherein the positioning block is provided with a first pin shaft, the button is provided with a first shaft hole configured to receive the first pin shaft, and the first shaft hole allows the first pin shaft to slide and rotate therein.

4. The telescopic shower according to claim 1, wherein the telescopic sleeve is provided with a positioning hole configured to allow the positioning block to penetrate through, an outer wall of the telescopic sleeve is provided with an orientation portion having a radial thickness, the orientation portion forms an orientation channel communicating with the positioning hole, and gap matching is provided between the orientation channel and the positioning block to limit inclination of the positioning block in the first direction.

5. The telescopic shower according to claim 4, wherein one end of the orientation channel away from the positioning hole is provided with a guiding surface connected to the orientation channel and inclined to an extending direction of the orientation channel, and the guiding surface is configured to receive the positioning block when the button swings to the second position.

6. The telescopic shower according to claim 1, wherein the button is provided with a second pin shaft, an outer wall of the telescopic sleeve is provided with a rotating shaft base, the rotating shaft base is provided with a second shaft hole rotatably matched with the second pin shaft, the second shaft hole is provided with a first opening, and a direction of the first opening is inclined relative to a movement direction of the positioning block.

7. The telescopic shower according to claim 1, further comprising a telescopic spring, wherein the telescopic spring is disposed between the telescopic sleeve and the water inlet pipe to drive the telescopic sleeve to be away from the water outlet portion.

8. The telescopic shower according to claim 7, wherein an inner wall of the telescopic sleeve is provided with a protruding block in a radial direction, the protruding block is provided with a spring receiving chamber extending in the first direction, the spring receiving chamber is provided with a second opening facing the water outlet portion, the spring receiving chamber is configured to receive the telescopic spring, the outer wall of the water inlet pipe is provided with a sliding groove in a radial direction, and the sliding groove extends in the first direction and is always inserted into the protruding block in a process when the telescopic sleeve slides relative to the water inlet pipe to form the limitation and matching of rotation.

9. The telescopic shower according to claim 8, further comprising an abutting block, wherein the abutting block is partially received in the spring receiving chamber, one end of the abutting block abuts against the telescopic spring, and the other end of the abutting block abuts against an abutting surface of the water inlet pipe facing the second opening.

10. The telescopic shower according to claim 1, further comprising an elastic member, wherein the elastic member is installed on the outer wall of the water inlet pipe and abuts against an inner wall of the telescopic sleeve.
